(19) United States
(12) Patent Application Publication
(10) Pub. No.: US 2023/0315154 A1
(43) Pub. Date: Oct. 5, 2023

(54) Foldable Display Support Systems for Thinner Foldable Devices and Improved User Experience

(71) Applicant: Google LLC, Mountain View, CA (US)

(72) Inventors: Adrian Gheorghe Manea, Libertyville, IL (US); Chu-Chun Lo, New Taipei City (TW); Yu-Chih Huang, Taoyuan (TW)

(73) Assignee: Google LLC, Mountain View, CA (US)

(21) Appl. No.: 18/328,998

(22) Filed: Jun. 5, 2023

Related U.S. Application Data
(60) Provisional application No. 63/505,930, filed on Jun. 2, 2023.

(51) Int. Cl. G06F 1/16; C09J 7/20

(52) U.S. Cl. CPC G06F 1/1641; C09J 7/20; C09J 2475/006

(57) ABSTRACT

This document describes foldable display support systems for thinner computing devices and improved user experience. In aspects, a device includes a foldable display coupled to the foldable display support system. The foldable display includes one or more primary folding regions of a first folding radius and one or more secondary folding regions of a second folding radius different than the first folding radius. The foldable display support system includes a support plate coupled to at least one other support plate by an adhesive layer. The support plate includes one or more flexible regions that correspond to the one or more primary folding regions of the foldable display, and the at least one other support plate includes one or more flexible regions that correspond to the one or more secondary folding regions of the foldable display. The flexible regions are configured to enable a consistent foldable display shape, which enables thinner foldable devices, improved robustness and waviness, and, thus, improved user experience.

### CROSS-REFERENCE TO RELATED APPLICATIONS

This claims priority to U.S. Provisional Application Ser. No. 63/505,930, filed Jun. 2, 2023, the disclosure of which is incorporated herein by reference in its entirety.

### SUMMARY

This document describes foldable display support systems for thinner foldable devices and improved user experience. In aspects, a foldable device includes a foldable display coupled to a foldable display support system. The foldable display includes one or more primary folding regions of a first folding radius and one or more secondary folding regions of a second folding radius different than the first folding radius. The primary folding regions may divide the foldable display into one or more equal or unequal segments, and, when folded, normal vectors of the one or more segments of the display may be oriented towards or away from each other. The one or more secondary folding regions are located differently from the one or more primary folding regions and, when folded, can realize a teardrop shape, a ‘Z’ shape, a ‘U’ shape, or another appropriate shape for the foldable display.

The foldable display support system includes a support plate coupled to at least one other support plate by an adhesive layer. The support plate includes one or more flexible regions that correspond to the one or more primary folding regions of the foldable display, and the at least one other support plate includes one or more flexible regions that correspond to the one or more secondary folding regions of the foldable display. The flexible regions, which include a pattern fully etched through the support plates, are configured to stretch and compress as the foldable display is folded and unfolded. The fully etched pattern may be more easily controlled in manufacturing so that the first folding radius and the secondary folding radius are consistent and predictable. The predictable and consistent folding radii of the flexible regions enable a consistent foldable display shape, which enables thinner foldable devices, reduces user-perceived creases and waviness, increases a perceived quality, and results in an improved user experience.

This Summary is provided to introduce simplified concepts of foldable display support systems for thinner foldable devices and improved user experience, which are further described in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of foldable display support systems for thinner foldable devices and improved user experience are described in this document with reference to the following drawings:

FIG. 1 illustrates an example implementation of a foldable device having a foldable display and a foldable display support system;

FIG. 2A illustrates a side view of an example implementation of a foldable display and a foldable display support system in an unfolded position;

FIG. 2B illustrates a side view of the foldable display and the foldable display support system from FIG. 2A in a folded position;

FIG. 3A illustrates a plan view of an example implementation of a support plate having a flexible region;

FIG. 3B illustrates a cross-section view of the support plate having the flexible region of FIG. 3A;

FIG. 4 illustrates a cross-section view of a first example implementation of a foldable display support system;

FIG. 5 illustrates a cross-section view of a second example implementation of a foldable display support system;

FIG. 6 illustrates a cross-section view of a third example implementation of a foldable display support system;

FIG. 7 illustrates a cross-section view of a fourth example implementation of a foldable display support system;

FIG. 8 illustrates a cross-section view of a fifth example implementation of a foldable display support system;

FIG. 9 illustrates a cross-section view of a sixth example implementation of a foldable display support system;

FIG. 10 illustrates a cross-section view of a seventh example implementation of a foldable display support system; and

FIG. 11 illustrates a cross-section view of an eighth example implementation of a foldable display support system.

### DETAILED DESCRIPTION

Overview

Foldable devices (e.g., smartphones, tablets, laptops, desktops) with foldable displays provide users with large display experiences in small display form factors. A foldable display can include one or more primary folding regions and one or more secondary folding regions. The folding regions may fold towards or away from each other to achieve one of a variety of foldable display shapes, such as a ‘Z’ shape or a ‘C’ shape. One foldable display shape may be chosen over another foldable display shape based on design considerations, such as having the foldable display on an inside or an outside of the foldable device when in a folded position.

Commonly, a foldable display includes one primary folding region that divides the display into two equal segments and two secondary folding regions that are generally equidistant from the primary folding region. The three folding regions allow the foldable display to achieve a teardrop-shaped fold, which enables foldable devices to be as thin as possible. However, unlike non-foldable displays, foldable displays do not include rigid support structures (e.g., thick cover glass layers, rigid device housings) and may be prone to creasing in folding regions. The lack of rigid support structures can reduce robustness and reliability of foldable devices. The creasing in folding regions can be seen, and perhaps felt, by users interacting with foldable displays, which negatively impacts user experiences. To address the reduced robustness, decreased reliability, and creasing in folding regions, manufacturers may include a support plate in a foldable display.

The support plate may be configured to ensure sufficient support for the foldable display through high rigidity in non-folding regions while enabling folding through low rigidity in folding regions. Commonly, manufacturers of foldable displays configure support plates to have a lowest rigidity in the primary folding region and a second-lowest rigidity in the secondary folding regions. The lowest rigidity in primary folding regions may be achieved by fully etching (e.g., chemically, physically) patterns (e.g., rectangles, squares, circles) through the support plates. The second-lowest rigidity in secondary folding regions may be achieved by partially etching (e g, thinning) patterns into the support plates. However, tolerances associated with partially etching patterns into the support plates in secondary folding regions can be large, resulting in large variations in the teardrop-shaped fold. These variations in foldable display shapes can worsen creasing and waviness in primary and/or secondary folding regions, and necessitate larger foldable devices to accommodate the variations, both of which negatively impact user experience.

Manufacturers of foldable devices may avoid the high tolerances associated with partially etching patterns by fully etching patterns into both the primary folding region and the secondary folding regions of the support plates. However, when foldable devices are in a folded position, the secondary folding regions are oriented convexly towards the foldable displays, which can result in the foldable displays delaminating from the support plates. Manufacturers often address this issue by utilizing an adhesive (e.g., a pressure-sensitive adhesive, a thermosetting adhesive) to couple the foldable displays to the support plates in the secondary folding regions. Unfortunately, the fully etched patterns of the secondary folding regions may be visible to users of the foldable devices when adhesive is used to couple the display to the secondary folding regions.

This document describes foldable display support systems for thinner foldable devices and improved user experience. The foldable display support systems address the issues of reduced robustness, decreased reliability, and visible waviness and creasing in folding regions. Rather than utilizing a single layer of support plates, the foldable display support systems utilize a sandwich, or stack, of support plates. Patterns may be fully etched into the support plates, avoiding issues of high tolerances associated with partially etching patterns and enabling thinner foldable devices. Additionally, support plates that are fully etched in secondary folding regions may be placed below support plates that are fully etched in primary folding regions so that foldable displays are not coupled (e.g., by adhesive) directly to fully etched patterns in the secondary folding regions. By so doing, the foldable display support systems avoid issues of visible patterns or delamination of foldable displays associated with coupling foldable displays directly to fully etched areas in secondary folding regions. Further, one or more of the support plates of the foldable display support systems may be optimized for lower weight via lighter materials or having additional patterns fully etched through the support plates.

### Example Implementations

The following discussion describes example implementations, techniques, apparatuses that may be employed in the example implementations, and various devices in which components of foldable display support systems for thinner foldable devices and improved user experience can be embodied. In the context of the present document, reference is made to the following by way of example only.

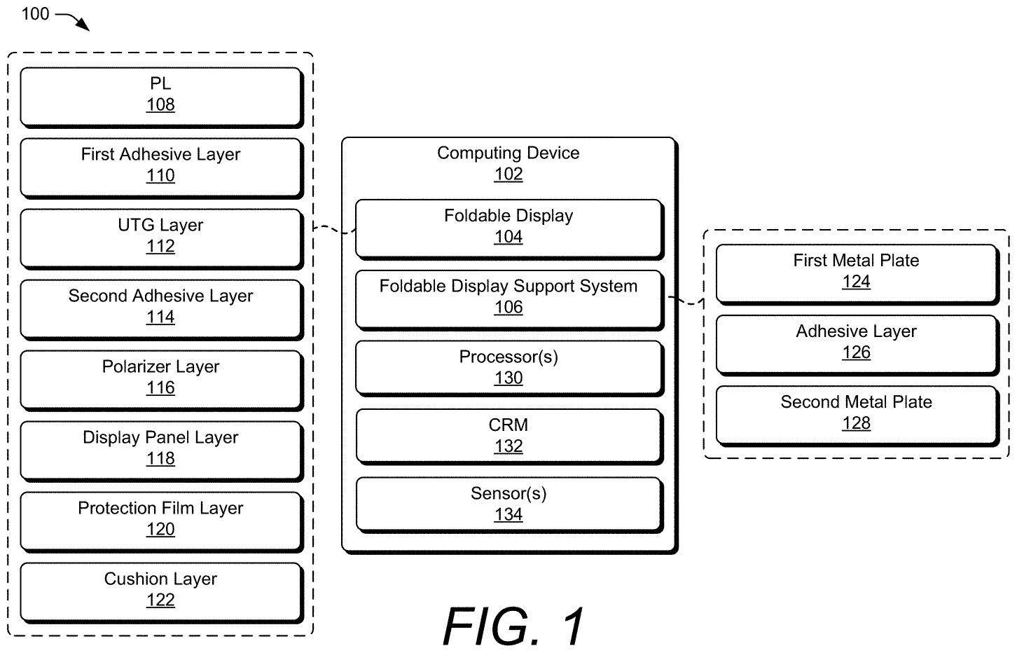

FIG. 1 illustrates, at 100 generally, an example implementation of a computing device 102 having a foldable display 104 (e.g., foldable display module, foldable display assembly) and a foldable display support system 106. The computing device 102 may be realized as various non-limiting example devices, including a smartphone, a tablet, a health monitoring device, a personal media device, a digital photo frame, a television, and so forth. The computing device 102 can be wearable, non-wearable but relatively mobile, or relatively immobile. Further, the computing device 102 can be used with or embedded within many devices or peripherals. The computing device 102 may also include additional interfaces or components omitted from FIG. 1.

The foldable display 104 may be realized as any one of a variety of display technologies. As non-limiting examples, the foldable display 104 may be a light-emitting diode (LED) display, an organic LED (OLED) display, an active-matrix OLED (AMOLED) display, a plastic OLED (POLED) display, a twisted nematic display, a liquid crystal display (LCD), and so forth. Further, the foldable display 104 may include one or more stacked layers as part of a display module, package, or otherwise assembly. The stacked layers may include a protection layer (PL) 108 as a top layer, a first adhesive (e.g., pressure-sensitive adhesive (PSA)) layer 110, an ultra-thin glass (UTG) layer 112, a second adhesive layer 114, a polarizer layer 116, a display panel (e.g., the POLED display) layer 118, a protection film (e.g., a polyimide) layer 120, and a cushion (e.g., foam, PSA) layer 122 as a bottom layer. In implementations, the cushion layer 122 can be realized as an adhesive layer or a film (e.g., polyethylene terephthalate (PET), polyimide) sandwiched between two adhesive layers.

A user may interact with the computing device 102 by touching a first side (e.g., a top side opposite the first adhesive layer 110) of the PL 108, which protects the underlying layers of the foldable display 104. The protection film layer 120 may protect a back side (e.g., a side facing away from a user) of the display panel layer 118, as well as any thin film transistors thereof, as a user unfolds and folds the computing device 102. The cushion layer 122 may help further protect the back side of the display panel layer 118 and absorb unintentional shocks (e.g., shocks resulting from accidental drops).

The foldable display 104 may include a first folding region of a first folding radius, a second folding region of a second folding radius, and a third folding region of the second folding radius. The first folding radius may be smaller than the second folding radius. The second and third folding regions may be generally equidistant from the first folding region and fold in an opposite direction compared to the first folding region. For example, the first folding region may fold in a concave orientation while the second and third folding regions fold in a convex orientation. In this way, the first, second, and third folding regions are configured to realize a teardrop shape when the foldable display 104 is in a folded position. The teardrop shape may enable a thinner computing device 102, which improves user experience.

The foldable display support system 106 may be attached (e.g., by an adhesive) to the foldable display 104 as a bottommost layer. Additionally or alternatively, the foldable display support system 106 may be included as a bottommost layer of the stacked layers of the foldable display 104 or the display module thereof. The foldable display support system 106 includes a first support plate 124, an adhesive layer 126, and a second support plate 128.

A support plate (e.g., first support plate 124, second support plate 128) of a foldable display support system (e.g., foldable display support system 106) disclosed herein can be formed of an appropriate material, including iron, aluminum, magnesium, copper, zinc, titanium, tungsten, nickel, cobalt, tin, lead, or an alloy thereof. Some alloys include brass, bronze, and stainless steel (e.g., steel use stainless (SUS)). Additional appropriate materials include carbon-fiber-reinforced plastic, glass-fiber-reinforced plastic, polycarbonate, and so forth. The first support plate 124 includes a first side (e.g., top side) that may be attached to a second side (e.g., bottom side) of the foldable display 104 or the cushion layer 122 thereof. The first support plate 124 further includes a second side (e.g., bottom side) that may be coupled to the adhesive layer 126, which may be coupled to a first side of the second support plate 128. The first support plate 124 includes a flexible region that corresponds to the first folding region of the foldable display 104. The second support plate 128 may include two flexible regions that correspond to the second and third folding regions of the foldable display 104. The flexible regions of the first support plate 124 and second support plate 128 may include a plurality of etched (e.g., chemically, physically) areas that have less material than non-flexible regions. The flexible regions may be configured to provide an accurate and reproducible teardrop shape when the computing device 102 is in a folded position.

An adhesive layer (e.g., first adhesive layer 110, second adhesive layer 114, adhesive layer 126) a foldable display support system (e.g., foldable display support system 106) disclosed herein can be any appropriate adhesive, including an epoxy, a polyurethane, an acrylic, a polyimide, a paste, a liquid, a film, a pellet, a hot melt, a reactive hot melt, a thermosetting, a pressure-sensitive, a contact, or a structural, non-structural, or semi-structural adhesive.

FIG. 1 further illustrates that the computing device 102 includes one or more processors 130, computer-readable media (CRM) 132, and one or more sensors 134 (e.g., barometers, accelerometers). The CRM 132 can include transitory and non-transitory storage, such as dynamic random-access memory (DRAM) and flash memory (e.g., a solid-state drive (SSD)), respectively. The CRM 132 may store instructions that the processors 130 can execute to provide some or all features and techniques described herein.

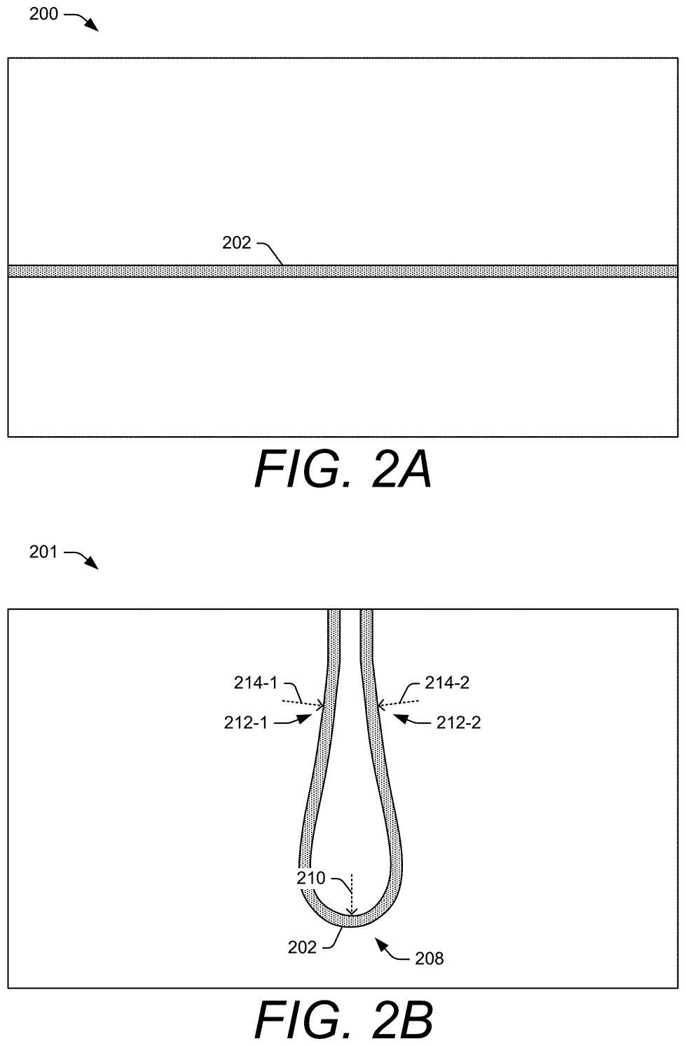

FIG. 2A illustrates, at 200 generally, a side view of an example implementation of a foldable display and a foldable display support system (e.g., the foldable display 104 and the foldable display support system 106 of FIG. 1) in an unfolded position. For purposes of clarity and brevity, the foldable display and the foldable display support system are illustrated as a foldable display module 202. The display module 202, when in the unfolded position as illustrated, forms a flat surface with which a user may interact.

FIG. 2B illustrates, at 201 generally, a side view of the foldable display and the foldable display support system from FIG. 2A in a folded position. Again, for purposes of clarity and brevity, the foldable display and the foldable display support system are illustrated as the foldable display module 202.

FIG. 2B further illustrates that, when in the folded position, the display module 202 achieves a teardrop shape. Although a teardrop shape is shown, it is provided as an example only. The foldable display may realize any appropriate shape, which may be enabled through tuning of various folding regions and respective radii of the foldable display module 202.

The teardrop shape is made possible by a first folding region 208, a second folding region 212-1, and a third folding region 212-2. The first folding region 208 includes a first folding radius 210, the second folding region 212-1 includes a second folding radius 214-1, and the third folding region 212-2 includes a third folding radius 214-2. In this implementation, the second folding radius 214-1 and the third folding radius 214-2 are equivalent and larger than the first folding radius 210. The first folding radius 210 may be in a range from one millimeter (mm) to five mm while the second folding radius 214-1 and the third folding radius 214-2 may be in a range from 10 mm to 35 mm Although not shown, the foldable display support system included in the foldable display module 202 includes flexible regions that correspond to the first folding region 208, the second folding region 212-1, and the third folding region 212-2.

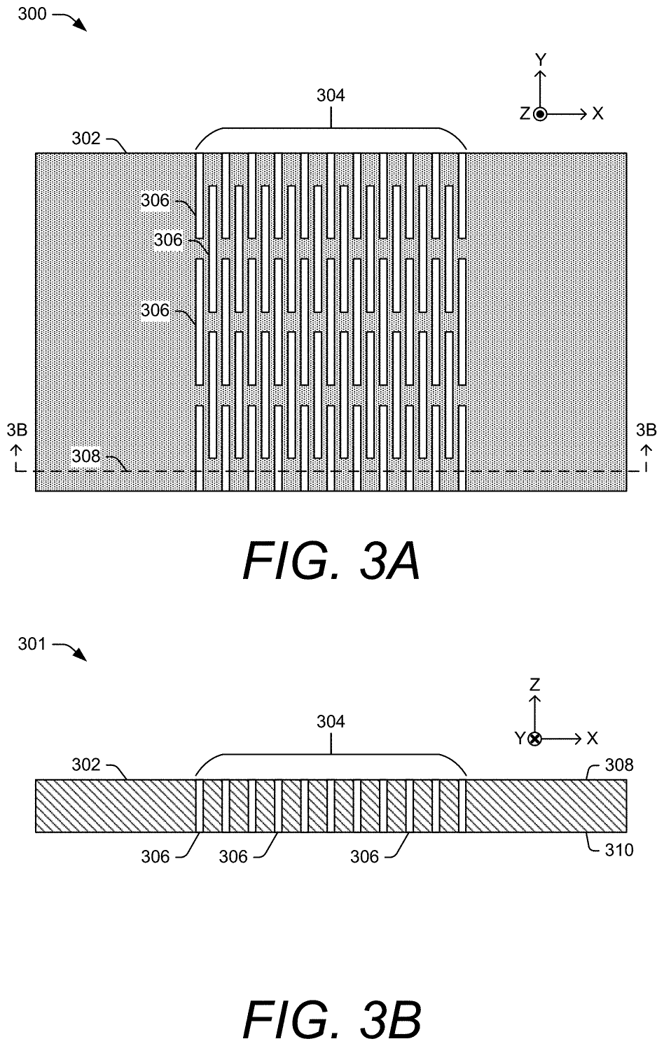

A foldable display support system (e.g., foldable display support system 106 of FIG. 1) of a computing device (e.g., computing device 102 of FIG. 1) may include one or more thermoplastic polyurethane (TPU) layers, at least one adhesive layer, and one or more support plates. FIG. 3A illustrates, at 300 generally, a plan view of an example implementation of a support plate 302 having a flexible region 304. The support plate 302 may be included in a foldable display support system for a thinner computing device and improved user experience.

As illustrated in FIG. 3A, the flexible region 304 of the support plate 302 includes a plurality of etched areas 306. In this implementation, the etched areas 306 are rectangles, but the shape of the etched areas 306 may be any appropriate shape, including circles, ovals, squares, triangles, trapezoids, and so forth. The plurality of etched areas 306 of the flexible region 304 include less material than non-flexible regions of the support plate 302. The flexible region 304 may enable the support plate 302 to stretch and compress during folding and unfolding, respectively, along the X-axis.

FIG. 3B illustrates, at 301 generally, a cross-section view of the support plate 302 having the flexible region 304 of FIG. 3A along line 3B-3B. As illustrated, the support plate 302 includes the flexible region 304 that may enable the support plate 302 to stretch and compress along the X-axis. Also illustrated is a selection of the plurality of etched areas 306, which are as tall as the support plate 302 is thick, extending from a first side 308 (e.g., a top side) to a second side 110 (e.g., a bottom side). The height of the etched areas and thus the thickness of the support plate 302 may be in a range from 20 micrometers (μm) to 120 μm. Described differently, the etched areas 306 of the support plate 302 do not include any material along the Z-axis.

This document now turns to various example implementations of foldable display support systems that include various layers. Each layer has a first side and a second side. The first side of each layer is oriented in a positive Z direction. The second side of each layer is oriented in a negative Z direction. Stated differently, the first side is a top side and the second side is a bottom side.

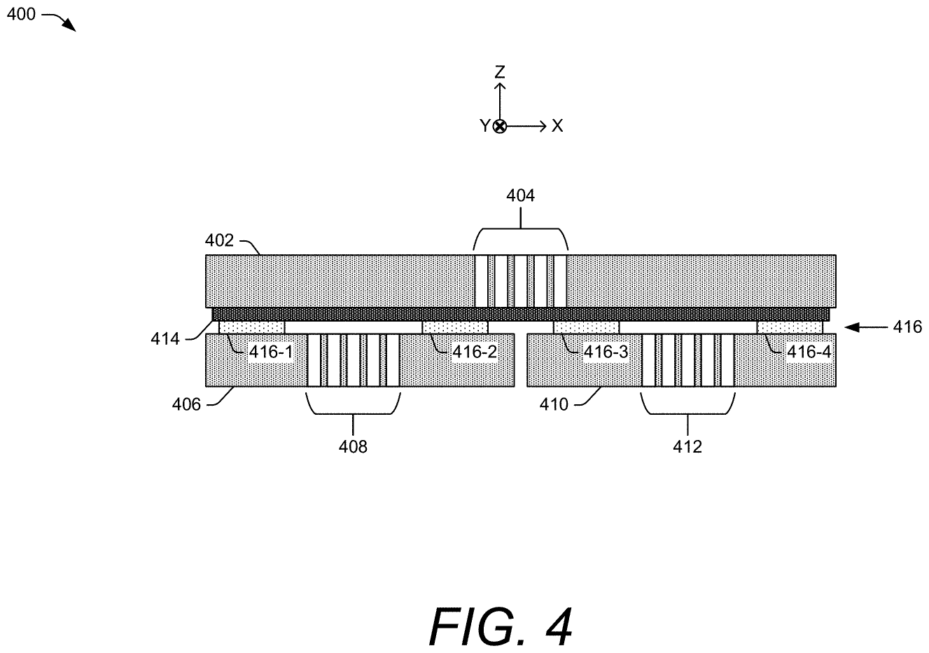

FIG. 4 illustrates a cross-section view of a first example implementation of a foldable display support system 400. The foldable display support system 400 is similar to the foldable display support system 106 illustrated in FIG. 1 and described above, except as detailed below. Thus, the foldable display support system 400 includes a first support plate 402, an adhesive layer 416, and a second support plate 406.

The foldable display support system 400 further includes a third support plate 410. As illustrated, the first support plate 402 includes a first flexible region 404, the second support plate 406 includes a second flexible region 408, and the third support plate 410 includes a third flexible region 412.

Although not shown, a first side (e.g., a top side) of the first support plate 402 may be attached (e.g., by an adhesive, by fasteners) to a foldable display (e.g., foldable display 104 of FIG. 1). The first flexible region 404 of the first support plate 402 may correspond to a first folding region (e.g., first folding region 208) of the foldable display. Stated differently, the first flexible region 404 may be oriented on a same Z-axis as a center of the first folding region of the foldable display.

FIG. 4 further illustrates that a second side (e.g., a bottom side) of the first support plate 402 is coupled to a first side of a TPU layer 414. Although TPU is described, it is provided as an example only. The TPU layer 414 may be formed of other appropriate materials, including rubber, elastomers, PET, and so forth. The TPU layer 414 may provide rigidity to the foldable display support system 400, and/or block debris (e.g., dust) from entering the first flexible region 404 from the second side of the support plate 402. In an aspect, the TPU layer 414 is 16 μm thick. A second side of the TPU layer 414 is coupled to a first side of an adhesive layer 416. In aspects, the adhesive layer 416 is six μm thick. In this implementation, the adhesive layer 416 is separated into a first segment 416-1, a second segment 416-2, a third segment 416-3, and a fourth segment 416-4. The segments of the adhesive layer 416 may be configured to secure the second side of the TPU layer 414 to a first side of the second support plate 406 and a first side of the third support plate 410.

The second support plate 406 and the third support plate 410 may be 30 μm thick. Although not shown, the second flexible region 408 of the second support plate 406 may correspond to a second folding region (e.g., second folding region 212-1) of a foldable display. Similarly, the third flexible region 412 of the third support plate 410 may correspond to a third folding region (e.g., third folding region 212-2) of a foldable display. The folding regions 404, 408, and 412 of the support plates 402, 406, and 410 may include a plurality of etched shapes configured to enable the support plates 402, 406, and 410 to stretch and compress along the X-axis during folding and unfolding, respectively. The flexible regions 404, 408, and 412 of the support plates 402, 406, and 410, respectively, may enable a consistent teardrop shape in the foldable display.

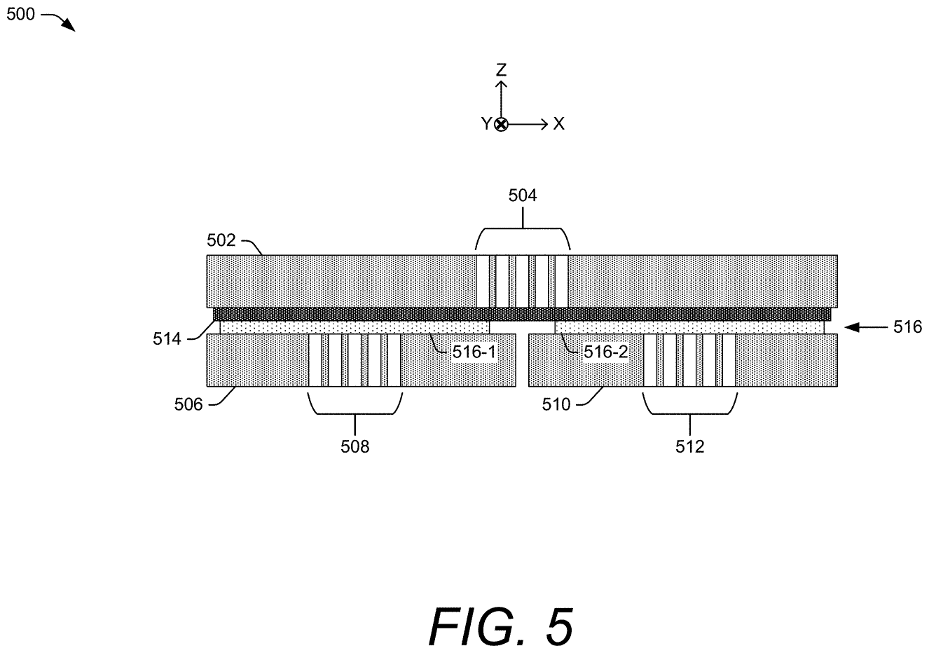

FIG. 5 illustrates a cross-section view of a second example implementation of a foldable display support system 500. The foldable display support system 500 is similar to the foldable display support system 106 illustrated in FIG. 1 and described above, except as detailed below. Thus, the foldable display support system 500 includes a first support plate 502, an adhesive layer 516, and a second support plate 506.

As illustrated, the foldable display support system 500 further includes a third support plate 510. The first support plate 502 includes a first flexible region 504, the second support plate 506 includes a second flexible region 508, and the third support plate 510 includes a third flexible region 512. The support plates may be any appropriate thickness, including a thickness in a range from 30 μm to 70 μm. A first side of the first support plate 502 may be coupled to a foldable display (not shown) having a first folding region of a first folding radius and two second folding regions of a second folding radius larger than the first folding radius. The first flexible region 504 may correspond to the first folding region of the foldable display. The second flexible region 508 and the third flexible region 512 may each correspond to one of the two second folding regions of the foldable display.

FIG. 5 further illustrates that a second side of the first support plate 502 is coupled to a first side of a TPU layer 514. A second side of the TPU layer 514 is coupled to a first side of an adhesive layer 516, which is separated into a first segment 516-1 and a second segment 516-2. A second side of the first segment 516-1 of the adhesive layer 516 is coupled to a first side of the second support plate 506. A second side of the second segment 516-2 of the adhesive layer 516 is coupled to a first side of the third support plate 510. Although not shown, second sides of the second support plate 506 and the third support plate 510 may be coupled (e.g., by adhesive, by fasteners) to a housing of a computing device.

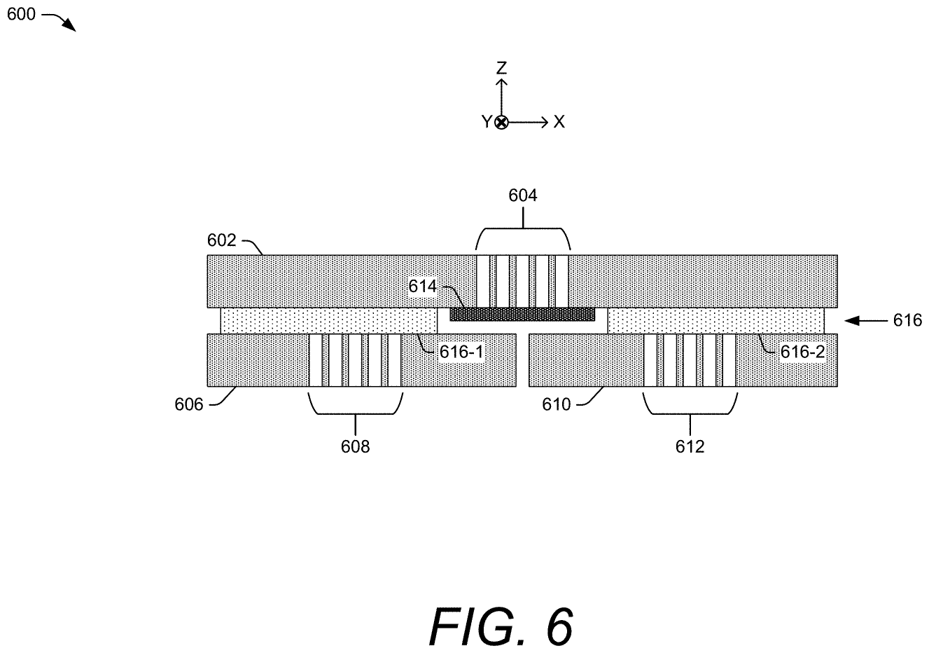

FIG. 6 illustrates a cross-section view of a third example implementation of a foldable display support system 600. The foldable display support system 600 is similar to the foldable display support system 106 illustrated in FIG. 1 and described above, except as detailed below. Thus, the foldable display support system 600 includes a first support plate 602, an adhesive layer 616, and a second support plate 606.

In this implementation, the foldable display support system 600 further includes a third support plate 610. As illustrated, the first support plate 602 includes a first flexible region 604, the second support plate 606 includes a second flexible region 608, and the third support plate 610 having a third flexible region 612. A first side of the first support plate 602 may be coupled to a foldable display (not shown) having a first folding region, a second folding region, and a third folding region. The first flexible region 604 of the first support plate 602 may correspond to the first folding region of the foldable display. Similarly, the second flexible region 608 and the third flexible region 612 may correspond to the second folding region and the third folding region, respectively, of the foldable display.

FIG. 6 further illustrates that a second side of the first support plate 602 is coupled to a first side of a TPU layer 614 and a first side of an adhesive layer 616, which is separated into a first segment 616-1 and a second segment 606-2. As illustrated, the TPU layer 614 and the first segment 616-1 and second segment 616-2 of the adhesive layer 616 reside in a same X-Y plane. The TPU layer 614 is sized appropriately to cover the first flexible region 604 on the second side of the first support plate 602. Second sides of the first segment 616-1 and the second segment 616-2 of the adhesive layer 616 are coupled to first sides of the second support plate 606 and the third support plate 610, respectively.

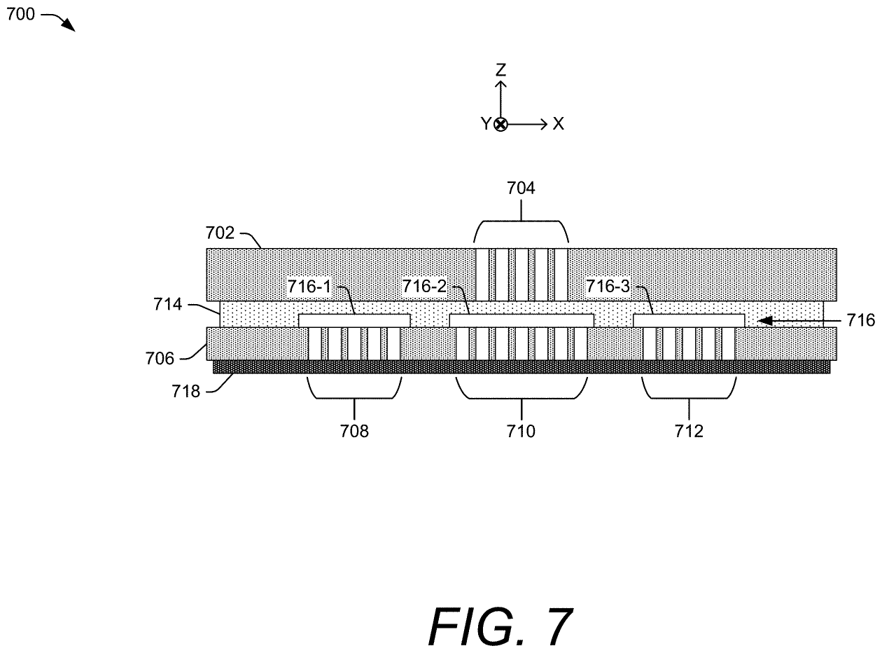

FIG. 7 illustrates a cross-section view of a fourth example implementation of a foldable display support system 700. The foldable display support system 700 is similar to the foldable display support system 106 illustrated in FIG. 1 and described above, except as detailed below. Thus, foldable display support system 700 includes a first support plate 702, an adhesive layer 714, and a second support plate 706.

As illustrated, the first support plate 702 includes a first flexible region 704. A first side of the first support plate 702 may be coupled to a foldable display (not shown) having a first folding region, a second folding region, and a third folding region (e.g., foldable display module 202). The first flexible region 704 includes a plurality of etched areas (e.g., etched areas 306) and may correspond to the first folding region of the foldable display.

FIG. 7 further illustrates that the second support plate 706 includes a first flexible region 708, a second flexible region 710, and a third flexible region 712. The first flexible region 708 may correspond to the second folding region of the foldable display. The second flexible region 710 may correspond to the first folding region of the foldable display. The third flexible region 712 may correspond to the third folding region of the foldable display. The second support plate 706 is coupled to the first support plate 702 via an adhesive layer 714.

As illustrated, a first side of the adhesive layer 714 is coupled to a second side of the first support plate 702 and a second side of the adhesive layer 714 is coupled to a first side of the second support plate 706. The adhesive layer 714 includes hollow regions 716 that are separated into a first hollow region 716-1, a second hollow region 716-2, and a third hollow region 716-3. As illustrated, the hollow regions 716 correspond to the first flexible region 708, the second flexible region 710, and the third flexible region 712 of the second support plate 706. The hollow regions 716 may be configured to enable the foldable display support system 700 to achieve a consistent teardrop shape. FIG. 7 further illustrates that a second side of the second support plate 706 is coupled to a TPU layer 718. In this implementation, the TPU layer 718 may prevent debris from entering the flexible regions 708, 710, and 712 through the second side of the second support plate 706.

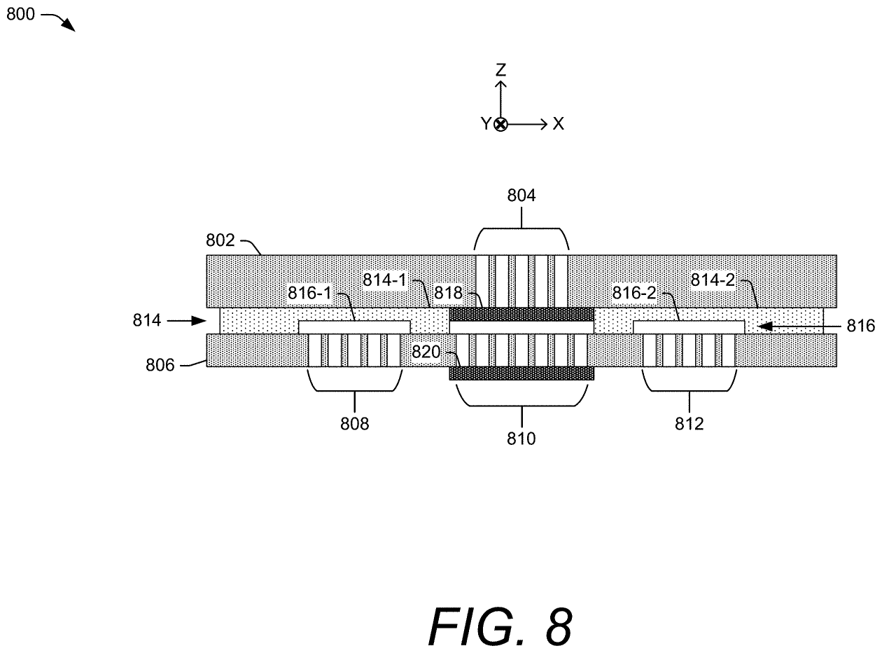

FIG. 8 illustrates a cross-section view of a fifth example implementation of a foldable display support system 800. The foldable display support system 800 is similar to the foldable display support system 106 illustrated in FIG. 1 and described above, except as detailed below. Thus, foldable display support system 800 includes a first support plate 802, an adhesive layer 814, and a second support plate 806.

As illustrated, the first support plate 802 includes a first flexible region 804. A first side of the first support plate 802 may be coupled to a foldable display (not shown) that includes first, second, and third folding regions. The first folding region may have a first folding radius while the second and third folding regions may have a second folding radius larger than the first folding radius.

A second side of the first support plate 802 is coupled to a first side of the adhesive layer 814, which is split into a first segment 814-1 and a second segment 814-2, and includes hollow regions 816. The first segment 814-1 includes a first hollow region 816-1 and the second segment 814-2 includes a second hollow region 816-2. A second side of the adhesive layer 814 is coupled to a first side of the second support plate 806, which has a first flexible region 808, a second flexible region 810, and a third flexible region 812.

The first flexible region 808 and the first hollow region 816-1 may correspond to the second folding region of the foldable display. The second flexible region 810 of the second support plate 806 and the first flexible region 804 of the first support plate 802 may correspond to the first folding region of the foldable display. The third flexible region 812 and the second hollow region 816-2 may correspond to the third folding region of the foldable display.

FIG. 8 further illustrates that the second side of the first support plate 802 is coupled to a first TPU layer 818 and that a second side of the second support plate 806 is coupled to a second TPU layer 820. The first TPU layer 818 and the second TPU layer 820 may correspond to the first folding region of the foldable display. The first TPU layer 818 and the second TPU layer 820 may be configured to block debris from entering the first flexible region 804 of the first support plate 802 and the second flexible region 810 of the second support plate 806, respectively. The TPU layers 818 and 820 may further be configured to add rigidity to the foldable display support system 800.

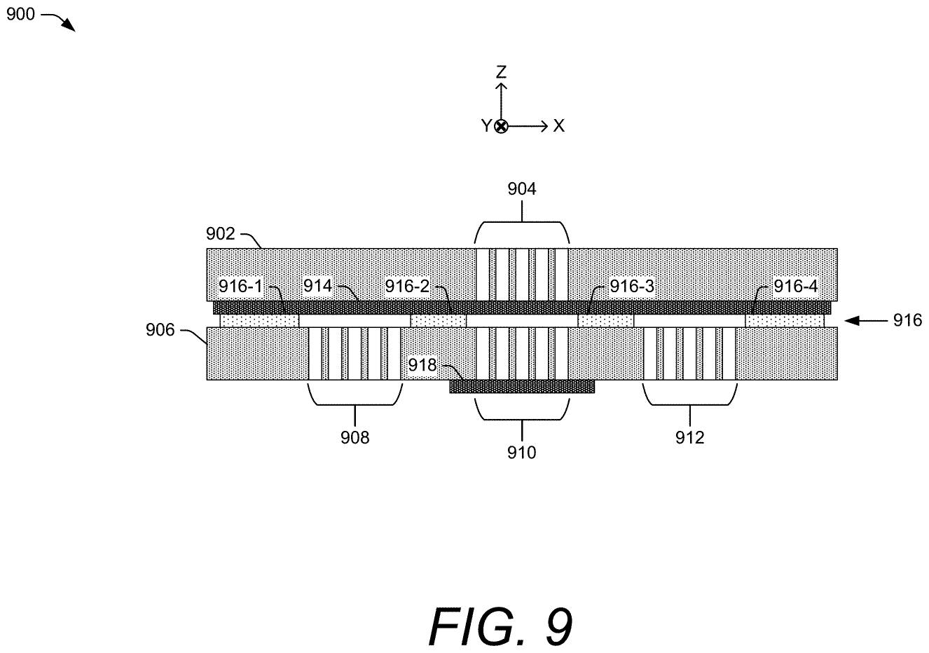

FIG. 9 illustrates a cross-section view of a sixth example implementation of a foldable display support system 900. The foldable display support system 900 is similar to the foldable display support system 106 illustrated in FIG. 1 and described above, except as detailed below. Thus, foldable display support system 900 includes a first support plate 902, an adhesive layer 916, and a second support plate 906.

In this implementation, the first support plate 902 includes a first flexible region 904. Although not shown, a first side of the first support plate 902 may be coupled to a foldable display having a first folding region of a first folding radius, a second folding region of a second folding radius larger than the first folding radius, and a third folding region of the second folding radius. The folding regions may be configured so that the foldable display achieves a teardrop shape when in a folded position. The first flexible region 904 of the first support plate 902 may correspond to the first folding region of the foldable display. FIG. 9 further illustrates that the second support plate 906 includes a first flexible region 908, a second flexible region 910, and a third flexible region 912 that may correspond to the second folding region, the first folding region, and the third folding region, respectively, of the foldable display.

Coupled to a second side of the first support plate 902 is a first TPU layer 914. In this implementation, the first TPU layer 914 covers nearly an entirety of the second side of the first support plate 902. The first TPU layer 914 may be configured to improve a robustness of or add rigidity to the foldable display support system 900. The first TPU layer 914 may further be configured to block debris from entering the first flexible region 904. A second side of the first TPU layer 914 is coupled to a first side of the adhesive layer 916, which is separated into a first segment 916-1, a second segment 916-2, a third segment 916-3, and a fourth segment 916-4. A second side of the adhesive layer 916 is coupled to a first side of the second support plate 906, a second side of which is coupled to a second TPU layer 918. The second TPU layer 918 may be configured similarly to the first TPU layer 914.

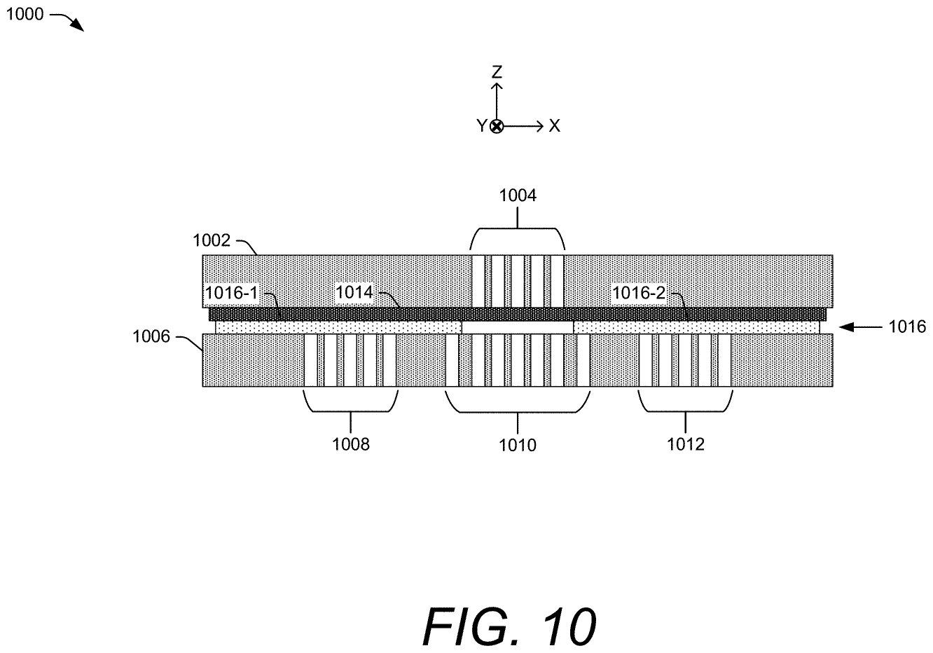

FIG. 10 illustrates a cross-section view of a seventh implementation of a foldable display support system 1000. The foldable display support system 1000 is similar to the foldable display support system 106 illustrated in FIG. 1 and described above, except as detailed below. Thus, foldable display support system 1000 includes a first support plate 1002, an adhesive layer 1016, and a second support plate 1006.

As illustrated, the first support plate 1002 includes a first flexible region 1004. A first side of the first support plate 1002 may be coupled to a foldable display (not shown) having first, second, and third folding regions. The first flexible region 1004 may correspond to the first folding region of the foldable display. A second side of the first support plate 1002 is coupled to a TPU layer 1014. The TPU layer 1014 may be configured to add rigidity to or improve a robustness of the foldable display support system 1000.

FIG. 10 further illustrates that a second side of the TPU layer 1014 is coupled to a first side of the adhesive layer 1016. The adhesive layer 1016 includes a first segment 1016-1 and a second segment 1016-2, which may correspond to the second and third folding regions of the foldable display. Coupled to a second side of the adhesive layer 1016 is a second support plate 1006, which includes a first flexible region 1008, a second flexible region 1010, and a third flexible region 1012. The first flexible region 1008 and the third flexible region 1012 may correspond to the second and third folding regions, respectively, of the foldable display. The second flexible region 1010, as illustrated, shares a same Z-axis with the first flexible region 1004, which may correspond to the first folding region of the foldable display.

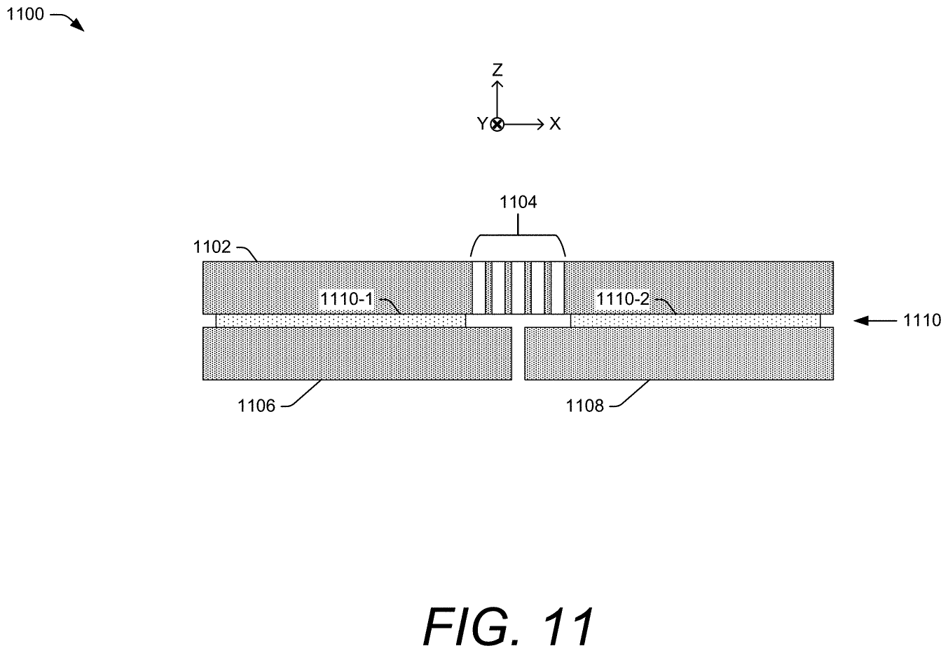

FIG. 11 illustrates a cross-section view of an eighth example implementation of a foldable display support system 1100. The foldable display support system 1100 is similar to the foldable display support system 106 illustrated in FIG. 1 and described above, except as detailed below. Thus, foldable display support system 1100 includes a first support plate 1102, an adhesive layer 1110, and a second support plate 1106.

The first support plate includes a flexible region 1104 that may include a plurality of etched areas so that the flexible region 1104 has less material than non-flexible regions of the first support plate 1102. The flexible region 1104 may correspond to a first folding region of a foldable display, which, although not shown, may be coupled to a first side of the first support plate 1102. A second side of the first support plate 1102 is coupled to a first side of an adhesive layer 1110 having a first segment 1110-1 and a second segment 1110-2.

FIG. 11 further illustrates that foldable display support system 1100 includes a third support plate 1108. Second sides of the first segment 1110-1 and the second segment 1110-2 of the adhesive layer 1110 are coupled to first sides of the second support plate 1106 and the third support plate 1108, respectively.

### CONCLUSION

Although concepts of techniques and apparatuses directed to foldable display support systems for thinner computing devices and improved user experience have been described in language specific to techniques and/or apparatuses, it is to be understood that the subject of the appended claims is not necessarily limited to the specific techniques or apparatuses described. Rather, the specific techniques and apparatuses are disclosed as example implementations of foldable display support systems for thinner computing devices and improved user experience.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

What is claimed is:

1. A device comprising:
a foldable display comprising:
one or more first folding regions of a first folding radius; and
one or more second folding regions of a second folding radius different than the first folding radius; and
a foldable display support system comprising:
a support plate having a first side and a second side, the first side of the support plate opposite the second side of the support plate, the first side of the support plate coupled to the foldable display, the support plate having one or more flexible regions corresponding to the one or more first folding regions of the foldable display;
an adhesive layer having a first side and a second side, the first side of the adhesive layer opposite the second side of the adhesive layer, the first side of the adhesive layer coupled to the second side of the support plate; and
at least one other support plate having a first side and a second side, the first side of the at least one other support plate opposite the second side of the at least one other support plate, the first side of the at least one other support plate coupled to the second side of the adhesive layer.

2. The device of claim 1, wherein:
the one or more first folding regions of the foldable display comprise a first folding region of the first folding radius;
the one or more second folding regions of the foldable display comprise a second folding region of the second folding radius and a third folding region of the second folding radius;
the second folding radius is larger than the first folding radius; and
the one or more flexible regions of the support plate comprise a flexible region corresponding to the first folding region of the foldable display.

3. The device of claim 2, wherein the flexible region of the support plate comprises a plurality of etched areas having less material than non-flexible regions.

4. The device of claim 2, wherein the at least one other support plate comprises:
a first flexible region corresponding to the second folding region of the foldable display; and
a second flexible region corresponding to the third folding region of the foldable display.

5. The device of claim 4, wherein the at least one other support plate comprises a third flexible region corresponding to the first folding region of the foldable display.

6. The device of claim 2, wherein:
the at least one other support plate comprises a first support plate and a second support plate, the first support plate having a first side and a second side, the first side of the first support plate opposite the second side of the first support plate, the second support plate having a first side and a second side, the first side of the second support plate opposite the second side of the second support plate;
the first side of the first support plate is coupled to the second side of the adhesive layer and in a location corresponding to the second folding region of the foldable display; and
the first side of the second support plate is coupled to the second side of the adhesive layer and in a location corresponding to the third folding region of the foldable display.

7. The device of claim 6, wherein:
the first support plate comprises a flexible region corresponding to the second folding region of the foldable display; and
the second support plate comprises a flexible region corresponding to the third folding region of the foldable display.

8. The device of claim 2, further comprising at least one thermoplastic polyurethane layer having a first side and a second side, the first side of the thermoplastic polyurethane layer opposite the second side of the thermoplastic polyurethane layer.

9. The device of claim 8, wherein at least one of:
the first side of the at least one thermoplastic polyurethane layer is coupled to the second side of support plate and the second side of the at least one thermoplastic polyurethane layer is coupled to the first side of the adhesive layer;
the at least one thermoplastic polyurethane layer is disposed between the support plate and the at least one other support plate; or
the at least one thermoplastic polyurethane layer is coupled to the at least one other support plate on a side opposite the adhesive layer.

10. The device of claim 8, wherein:
the at least one thermoplastic polyurethane layer comprises a first thermoplastic polyurethane layer and a second thermoplastic polyurethane layer;
the first thermoplastic polyurethane layer is disposed between the support plate and the at least one other support plate; and
the second thermoplastic polyurethane layer is coupled to the at least one other support plate on a side opposite the adhesive layer.
